(19) United States
(12) Patent Application Publication
(10) Pub. No.: US 2005/0147476 A1
(43) Pub. Date: Jul. 7, 2005

(54) Cutting tool for the in-process control of the residual wall thickness for the airbag weakening and method for this

(76) Inventor: Andreas Wieners, Viersen (DE)

Correspondence Address: Friedrich Kueffner;Suite 910, 317 Madison Avenue, New York, NY, 10017, US

(21) Appl. No.: 10/758,691

(22) Filed: Jan. 15, 2004

(30) Foreign Application Priority Data
Jan. 15, 2003 (DE) 203 00 628.3
Sep. 12, 2003 (DE) 203 14 281.0

(51) Int. Cl. B27C 3/00

(52) U.S. Cl. 408/21

(57) ABSTRACT

The device with a cutting tool for producing a material predetermined breaking point for the release of airbags integrated in instrument panels, in side trims of doors of a vehicle and in the steering wheel hub as passenger protection consists in that, for the in-process control of the residual wall thickness of indented materials for the formation of weakening lines or of predetermined breaking and separating lines, at least one distance sensor (85) with a principle of measurement is provided on the cutting head (10) of the cutting tool (100) next to the cutting blade (35) thereof or next to the cutting tool connected with the guiding and movement device thereof for measuring the distance to the cutting counterplate (81).

### TECHNICAL FIELD

This invention relates to a cutting tool according to the preamble of claim 1 as well as a method according to the preamble of claim 7.

### PRIOR ART

A passenger retaining device with an inflatable gas or air bag—hereunder designated as “airbag” or “airbag unit”—is supposed, like a safety belt, to protect the driver of a vehicle and/or the passengers from injuries in case of accidents and is generally installed additionally to the safety belts.

As to the mode of operation of an airbag, it should be considered that it becomes effective only at speeds from approximately sixteen kilometers per hour. Then, in case of a strong deceleration or acceleration of the vehicle—as for a safety belt too—an electric or electronic sensor ignites a pyrotechnic grain. The gas released fills the airbag within a few milliseconds, this airbag retaining the driver of the vehicle and/or the passengers. The airbag then discharges immediately completely so that the driver of the car and/or the passengers can move again.

As already mentioned, airbags are used in vehicles not only for the driver of the vehicle but increasingly also for the passengers, namely as front protection as well as side airbags for the protection against a lateral collision.

The drivers airbag for the protection against frontal collisions has its “natural” place in the steering wheel hub and thus fits casually in the interior space configuration of the vehicle; on the other hand, passenger and side airbags require installation places which decisively determine the general impression of the interior space of the vehicle, namely the free surface of the dashboard in front of the front seat passenger and the side trims of the doors of the vehicle.

Complete airbag units, i.e. ready to be installed combinations of the trim, airbag and gas generator, interrupt these “configuration surfaces” by colour and/or pattern differences, but in particular by the created “joint pattern” which is often irregular and thus unsightly because of unavoidable fitting tolerances.

Thus, there prevails the tendency to fix front seat passenger and side airbags so as to be “invisible”, i.e. to place them behind continuous laminations or interior space rim parts of the type mentioned in the introduction, as they are known for example from the documents DE 195 40 563 A1, DE 196 36 428 A1 or DE 199 37 373 A1.

Because of respective design prescriptions for the interior space configuration of vehicles, the automobile industry requires increasingly instrument panels with invisible front seat passenger airbag. For this purpose, the surface layer (=mostly foil or “skin”), the foam and the carrier of the instrument panel must be provided with predetermined breaking points so that, when releasing the airbag grain, a flap-shaped segment of the instrument panel opens and the airbag can deploy.

According to the prior art, for this purpose, for special airbag complete units, the covers of the guide channel for the airbag are constituted as single wing or two-wing flaps which are swivelling about “plastic hinges” and thus release a through opening under the pressure of the expandable airbag. This prior art is basically kept up even for the “invisible” installation of the airbag.

This being, “hinged grooves”, i.e. weakenings of the cross-section of the carrier part, which form a “plastic” hinge, eventually reinforced with an integrated intermediate metal ply, and “tear-off grooves” which are to guarantee the opening of the flaps, predetermine the opening area for the airbag in the continuous trim. The flaps limited by these grooves open to the passenger compartment under the pressure of the expandable airbag so that the airbag can expand here (see for example the printed document DE 295 11 172 U1).

This being, the problem is the tearing behaviour of the lamination during the necessary superficial fissure as well as during the further tearing which should take place as symmetrically as possible in order not to endanger the function of the airbag. Thus, it is usual (see for example the printed document DE 295 11 172 U1) to weaken the lamination along the seam to tear also in cross-sectional direction, thus to notch here. A cross-sectional weakening of more than sixty percent is considered as being necessary and is in part prescribed in works standards.

But this procedure still has a number of disadvantages:
The formation of large-surface flaps when opening the airbag channel involves the danger of the tearing-off of these flaps which then mean an additional risk of injury in the passenger compartment.
To carry out definitely a more than 50% cross-section weakening requires, considering the thickness tolerance of the laminating foils, a considerable expenditure of production and control.
The necessary cross-section weakening of the laminating foil is so big that there prevails the risk that this area stands out on the visible side.

Therefore, there are proposals to actuate separately cutting knives with the expandable airbag in order to guarantee, regardless of tolerances in the laminating foil thickness, a defined tear opening of the lamination (see for example the printed document U.S. Pat. No. 5,316,335); however, a mode of procedure is to be seen herein which requires an additional expenditure of production and for which the relatively “robust” knives mean a further risk of injury because the knives cut the carrier part as well as the lamination.

In further tests, foils per se, which are weakened according to the arrangement of the airbag, have been stretched conventionally, whereby the weakening of the tear-off edge takes place in longitudinal direction for example with a laser.

But this type of weakening is very sensitive to tensile load transversely to the tear-off seam because the seam is then stretched out and the tear-off edge gapes so as to become permanently visible. Such a tensile load transversely to the tear-off edge exists for example in the area of vaults because there develop tensile forces in circumferential direction over a vaulted surface when stretching the foil. Due to the weakening, for example due to small cuts or pores, there only remains in the foil a residual cross-section of the non weakened sections which must support the tensile forces accordingly.

For certain materials, due to the gaping of the weakening, edges are created which can lead, by contact with the skin, to skin lesions such as, for example to grazes. This latter risk exists in particular when using the foil for covering a knee airbag module because here the distance between the foil and the passenger of the vehicle is very short.

Furthermore, it is disadvantageous that visible big gaps of the weakening make possible an undesired dirt bonding as well as a light dirt or moisture passage through the weakening. For the lamination of the interior space of a vehicle, in particular the knee area of the board or the instrument panel are areas with vaulted surfaces which are covered by such a foil and for which the problems described above appear.

In order to avoid the above mentioned difficulties, an ultrasonic cutting method is established for conventional surface materials such as, for example, P[oly]V[inyl]C[hloride] or T[hermo]P[lastic]O[lefins] for producing the predetermined breaking point. This being, a cut is made with a scalpel-type blade on the rear surface of the skin. On the machine side, the blade is guided along the desired contour, whereby the residual wall thickness of the skin is defined by the depth adjustment of the machine.

The longitudinal movement of the knife necessary for the low-reaction cutting is produced by an ultrasonic sonotrode which lets oscillate the knife longitudinally with a frequency of approximately twenty kilohertz and with an amplitude of approximately twenty micrometers. In the automobile industry, the term “scoring” has become established for this method.

P[oly]U[rethane] increasingly gains in importance at present as a cost favourable and ecological alternative to the above mentioned skin materials (P[oly]V[inyl]C[hloride], T[hermo]P[lastic]O[lefins] . . . ), what becomes apparent in increasing market shares. P[oly]U[rethane] skins can be produced by casting in closed moulds or by injection moulding in open moulds.

It turned out when indenting materials such as, for example, materials made
of P[oly]U[rethane] elastomers,
of P[oly]V[inyl]C[hloride],
of T[hermo]P[lastic]E[lastomers],
of T[hermo]P[lastic]E[lastomers] on Polyether-E[ster-base],
of T[hermo]P[lastic]O[lefins] and/or
of T[hermo]P[lastic Poly]U[rethanes]
   as structural skin, as slush skin, as injection moulded skin and/or as casting skin by keeping up a residual wall thickness of the material with such cutting tools for producing a material predetermined breaking point for the release of airbags integrated into instrument panels, in side trims of doors of a vehicle and in the steering wheel hub as passenger protection that the admissible tolerance extent of the residual wall thickness of the material skin diminishes to ±30 micrometers depending on the marginal conditions.

Machines are necessary to obtain this exactness for which the geometrically and thermally dependent accuracy can be guaranteed only by expensive measures. The investment costs of such machines are very high.

A prior solution consists in the use of a considerably cheaper articulated arm robot which can describe all the required translational and rotary degrees of freedom with six ranged rotational axes. However, in spite of a sufficient path accuracy, the robot cannot put up a sufficient rigidity to the reaction power from the process in order to avoid a dynamic bending up of the arrangement and thus an unacceptably high deviation from the path.

### DESCRIPTION OF THE INVENTION: AIM, SOLUTION, ADVANTAGES

Starting from the disadvantages and inadequacies explained above as well as by appraisal of the outlined prior art, the aim of this invention is to configure a device with a cutting tool for the purpose of production of a material predetermined breaking point for the release of airbags incorportated in instrument panels, in side trims of doors of a vehicle and in the steering wheel hub as passenger protection in such a way that the device is able to detect dynamic variations between a tool tip (cutting blade) and a cutting counterplate with a high resolution and to compensate them immediately so that the cutting robot can observe with simple control technical means a narrow tolerance extent like the considerably more expensive machines by constituting residual walls in the indented material.

This aim is achieved according to the teaching of this invention by a cutting tool with the characteristics mentioned in claim 1 as well as by a method with the characteristics mentioned in claim 7. Advantageous configurations and appropriate further developments of this invention are characterized in the respective subclaims.

Accordingly, the invention consists in the fact that, for the in-process control of the residual wall thickness of indented materials for the formation of weakening or predetermined breaking and separating lines, i.e. for the airbag weakening, at least one distance sensor with a principle of measurement is placed on the cutting head of the cutting tool next to the cutting blade thereof or next to the cutting tool connected with the guiding and movement device thereof for measuring the distance to a cutting counterplate.

The principle of measurement is chosen according to the teaching of this invention so that the sensor signal cannot be influenced in any way by a mould skin situated in the cutting seat, whereby the sensor signal serves as a measurable variable of a control circuit for which the distance between the tool tip or the cutting blade and the cutting counterplate is the regulating variable. The robot controlled device with its position control circuit or at least one additionally interconnected adjusting axle can act as an actuator.

Furthermore, the invention provides for a method for the in-process control of the residual wall thickness for the airbag weakening by means of a motion controlled cutting tool, i.e. in particular of a program controlled and/or robot controlled cutting tool for materials, in particular made of PU elastomers, of PVC, of TPE, of TPE-E (thermoplastic elastomers on polyester base), of TPO and/or of TPU as structural skin, slush skin, as injection moulded skin and/or casting skin.

The cutting tool has at least one cutting head with a cutting blade, with a blade holder for the cutting blade and with a driving device which sets the blade holder with the cutting blade into a preferred oscillating or pulsating cutting movement; alternatively or additionally, the cutting tool can be set into a drawing forward movement which produces the cut by the robot controlled device.

According to the teaching of this invention, the method itself consists in that the cutting blade for producing weakening structures along a predetermined breaking line in the material of the airbag trim is moved with at least a predetermined forward speed along the predetermined breaking line and the material is indented.

This being, the distance of the distance sensor to a cutting counterplate receiving the material to be indented is measured by means of at least one distance sensor placed besides the cutting tool and guided together with the cutting tool.

The residual wall thickness is then calculated from the distance measured between the distance sensor and the cutting counterplate minus the predetermined value kept constant during the cutting procedure for the distance of the distance sensor to the base, i.e. to the bottom surface of the indent in the material, whereby the cutting blade depth is automatically readjusted in case of deviations.

Furthermore, the invention provides for that, for the in-process control of the residual wall thickness of indented materials for the airbag weakening, at least one distance sensor with a principle of measurement is placed on the cutting head of the cutting tool next to the cutting blade thereof or next to the cutting tool connected with the guiding and movement device thereof for measuring the distance to a cutting counterplate, the principle of measurement being chosen such that the sensor signal is in no way influenced by a mould skin situated in the cutting seat.

This being, the sensor signal is used as a measurable variable of a control circuit for which the distance between the tool tip or the cutting blade and the cutting counterplate is the regulating variable, whereby the robot controlled device with its position control circuit or an additional interconnected adjusting axle acts as an actuator; the residual wall thickness is calculated from the value of the distance between the distance sensor and the cutting counterplate minus the predetermined height difference between the distance sensor and the blade tip.

With the cutting tool configured according to the invention, a high accuracy for the production of the residual wall thickness of the skin is achieved without expensive measures or without expensive devices. The disadvantages resulting from the prior known devices are avoided.

Thus, the machine is able to detect dynamic variations between the tool tip and the cutting counterplate with a high resolution and to compensate them immediately; insofar the cutting robot can observe with simple control technical means a narrow tolerance extent as it is otherwise possible only with considerably more expensive machines.

Finally, this invention relates to the use of at least one cutting tool according to the type described above and/or of a method according to the type described above for the production of airbag trims with weakening structures, in particular for the formation of weakening lines or of predetermined breaking and separating lines in materials provided for the trim of airbags, for example made of
of P[oly]U[rethane] elastomers,
of P[oly]V[inyl]C[hloride],
of T[hermo]P[lastic]E[lastomers], even on polyester or polyester/ester base,
of T[hermo]P[lastic]E[lastomers] on Polyether-E[ster-base],
of T[hermo]P[lastic]O[lefins] and/or
of T[hermo]P[lastic Poly]U[rethanes]
   as structural skin, slush skin, as injection moulded skin and/or as casting skin.

### SHORT DESCRIPTION OF THE DRAWINGS

As it has already been mentioned, there are different possibilities to configure and further develop advantageously the teaching of this invention. To this, reference is made, on the one hand, to the claims subordinate to the claims 1 and 7, on the other hand further configurations, characteristics and advantages of this invention will be explained in detail below with reference to the embodiment illustrated by the FIGS. 1 and 2.

FIG. 1 shows a schematical partial sectional view of a cutting head with a cutting blade of an embodiment for a cutting tool according to this invention, whereby a distance sensor of a cut depth recognition device placed externally to the cutting head.

FIG. 2 shows a schematical partial sectional view of a detail of FIG. 1.

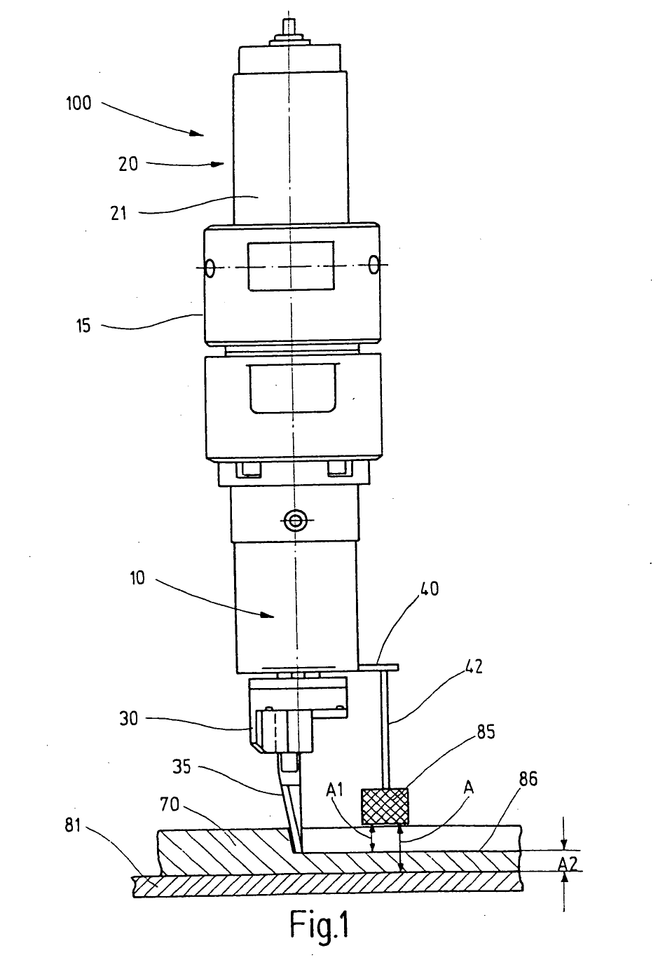

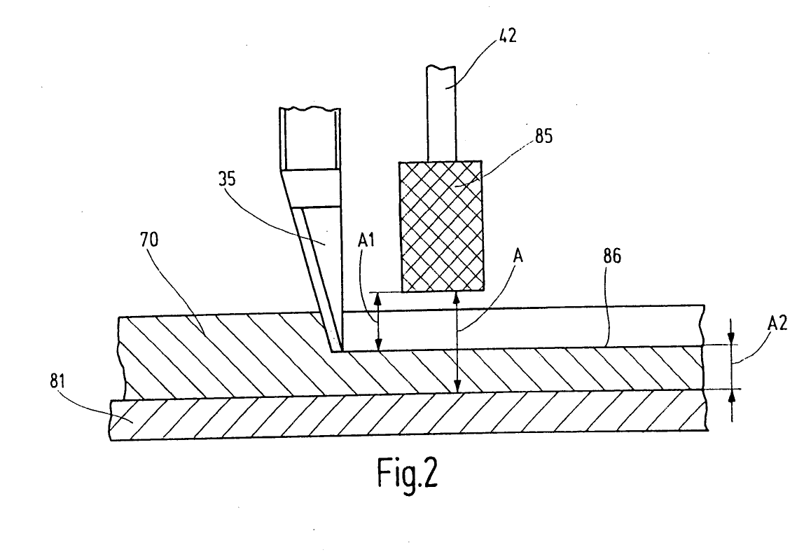

The same or similar configurations, elements or characteristics have identical reference numerals in the FIGS. 1 and 2.

### BEST WAY OF CARRYING OUT THE INVENTION

The cutting tool according to the invention 100 for materials 70, in particular for p[oly]U[rethane] elastomers, for P[oly]V[inyl]C[hloride], for T[hermo]P[lastic]E[lastomers], for T[hermo]P[lastic]E[lastomers] on Polyether-E[ster-base], for T[hermo]P[lastic]O[lefins] and/or for T[hermo]P[lastic Poly]U-[rethanes] comprises preferably a cutting head 10 with a driving device 20, which is configured as a driving motor 21 in a casing 15, with a blade holder 30 and with a cutting blade 35 which is placed interchangeable in the blade holder 30 (see FIG. 1, so-called “Vocks head”).

However, the realization of the cutting tool 100 according to this invention is also possible with at least one ultrasonic head or with at least one fixed blade. In any case, the cutting tool 100 has at least one cutting head 10, whereby the cutting tool 100 can also be provided with two cutting heads 10 or more.

The movement of the cutting tool 100 is carried out by means of a robot or by means of an appropriate control device with which the movement pattern of the cutting tool 100 is controlled in accordance with a predetermined cutting pattern. By using a drawing cutting knife 35, the forward movement of the cutting head 10 is controlled over the robot or over the control device.

All the cutting operations, cutting paths and the like are preferably automatically controlled with a guiding and movement device which is not represented in the drawing for reasons of clarity.

The oscillation of the knife 35 is mechanically guided by an axial curve (comparable with the movement of a valve of an Otto engine which is guided or controlled by the shape of the camshaft). The path curve described by the cutting blade 35 on the mould skin 70 is described by a program, whereby it should be insignificant whether the path curve is transferred by the movement of a robot or of another machine.

A distance sensor 85 is placed on the cutting head 10 of the cutting tool 100 next to its cutting blade 35 above the material 70 to be indented placed on the cutting counterplate 81. The distance of the distance sensor 85 to the cutting blade 35 should be chosen short. The distance A of the distance sensor 85 to the cutting counterplate 81 is measured with the distance sensor 85.

This being, the distance sensor 85 is configured as an example as a cylindrical body which is connected with the cutting head 10 of the cutting tool over a relatively solid connection 40, 42. The distance sensor 85 is based on an inductive function principle, whereby the inductive sensor is adjusted in such a way that the distance of the inductive sensor to an electrically conductive object is detected.

Since the skin material 70 is not electrically conductive and since it is, for this reason, “invisible” for the distance sensor 85, the distance A to the cutting counterlayer 81 is measured by the distance sensor 85 since this cutting counterlayer (=counterplate 81) is of steel (about this, see also FIG. 2). The height difference A1 (see also FIG. 2) between the distance sensor 85 and the tip of the cutting blade 35 is measured by means of an appropriate measuring instrument. Thus, for the cutting operation, this distance value A1 is known and constant. The present residual wall thickness A2 (see also FIG. 2) which is specified perpendicularly to the surface 86 of the cut skin 70 is then calculated from the presently measured distance A minus the constant distance A1. This value A2 is supplied to the control as the present actual value.

With respect to the height of the distance sensor 85 above the material to be cut 70, it must be considered that this material to be cut 70 can be submitted to thickness variations up to approximately 0.4 millimeter because the material 70 is produced for example by a p[oly]U[rethane] injection process in an open mould.

With the teaching according to this invention, it is possible, in spite of these thickness variations, to make an indent with an exactly constant residual wall thickness A2. The height of the distance sensor 85 above the material to be cut can be changed insofar as this height depends on the varying thickness of the material 70.

According to a further development of this cutting tool 100 which is essential to the invention, the arrangement of the distance sensor 85 can also take place in an appropriate manner on the guiding and movement device for the cutting tool 100.

The on-line principle of measurement of the distance sensor 85 provided for the detection of the residual wall thickness A2 is selected such that the signal of the distance sensor is in no way influenced by a moulded skin (thickness, colour, material, grain or the like) situated in the cutting seat because the skin material 70 is not electrically conductive and is, for this reason, “invisible” for the distance sensor 85 (see above; if the moulded skin would influence the measuring signal, the measuring signal could not be used as a measure for the residual wall thickness A2).

Concerning the in-process control of the residual wall thickness A2 of the indented material 70, “in-process” means that this control takes place parallel in time with the processing. The sensor signal now serves as measured variable of a control circuit for which the distance between the tip of the cutting tool 100 and the cutting counterplate 81 is the regulating variable.

For example an external additional interconnected adjusting axle with an own control can serve as an actuator. Such an additional interconnected adjusting axle constitutes technically a solution if the control used does not allow for the possibility to process a measured variable in the position control.

In this case, an additional linear axle of motion can be fixed in axle direction of the cutting head 10. The additional movement is then superimposed, not by a control technique but mechanically so that an external control is necessary for this.

According to an alternative or to a further development of this invention, a control on C[omputerized] N[umerical] C[ontrol] base (CNC=computerized numerical machine control) can also be used as far as this CNC-control disposes of the possibility to process a measured variable in the position control.

An external additional interconnected adjusting axle with an own control or even a CNC-control is to be considered as being configured like a robot with a position control circuit described below.

The robot itself with its position control circuit can also act alternatively or additionally as an actuator, whereby in this case the information for the actuator is taken from the control circuit in the position adjustment of the robot control.

In the exemplary case that the robot itself serves with its position control as an actuator, this position control circuit is integrated into the control of the machine, and in particular into the position adjustment of the control. The sole connection produced to the cutting tool 100 consists in that the measured variable, i.e. the signal of the distance sensor 85, is amplified and fed to an analog interface of the control in the control circuit.

In this case, the machine is an articulated arm robot but it can just as well be a conventional Cartesian machine with an x-axle, an y-axle and a z-axle.

As far as the machine however does not dispose of the function of an external superimposed control circuit, it is also possible to use an external additional control, for example a P[ersonal]C[omputer] based control. It basically applies that the control circuit is configured substantially alike, namely irrespective of whether the control circuit is integrated into a robot or into a machine.

The control circuit serves to keep constant the measuring signal. When the signal—for example due to disturbance variables—differs from the nominal value, the control circuit produces a correcting variable opposite to the disturbance variable.

In this connection, the external signal is fed as superimposed measured variable. In the control, the correcting variable produces a correcting movement exactly in vertical direction.

### List of Reference Numerals

100 Cutting tool
10 Cutting head
15 Casing
20 Driving device
21 Driving motor of the driving device 20
30 Blade holder
35 Knife blade or cutting blade
40 (first component of the) connection between cutting head 10 and distance sensor 85
70 Material to be cut, in particular skin material
81 Cutting counter layer or cutting counterplate
85 Distance sensor
86 Ground surface of the cut into the material 70
A Distance between the distance sensor 85 and the cutting counterplate 81
A1 Height difference between distance sensor 85 and tip of the cutting blade 35
A2 Residual wall thickness=Distance A minus height difference A1

1. Cutting tool (100) for materials (70), in particular made
of P[oly]U[rethane] elastomers,
of P[oly]V[inyl]C[hloride],
of T[hermo]P[lastic]E[lastomers],
of T[hermo]P[lastic]E[lastomers] on Polyether-E[ster-base],
of T[hermo]P[lastic]O[lefins] and/or
of T[hermo]P[lastic Poly]U[rethanes]
as structural skin, as slush skin, as injection moulded skin and/or as casting skin, which cutting tool (100) is controlled in its motion, in particular program and/or robot controlled, comprising at least one cutting head (10)
with at least one cutting blade (35),
with at least one blade holder (30) for the cutting blade and
with at least one driving device (20) setting the blade holder (30) with the cutting blade (35) into an oscillating or pulsating cutting movement or
with at least one robot controlled device setting the blade holder (30) with the cutting blade (35) into a drawing forward movement producing the cut, in particular for airbag trims with weakening structures,
wherein,
for the in-process control of the residual wall thickness (A2) of the indented materials (70) for the formation of weakening lines or of predetermined breaking and separating lines, i.e. for the airbag weakening, at least one distance sensor (85) with a principle of measurement is provided on the cutting head (10) of the cutting tool (100) next to the cutting blade (35) thereof or next to the cutting tool (100) connected with the guiding and movement device thereof for measuring the distance to a cutting counterplate (81), the principle of measurement being chosen such that the sensor signal cannot be influenced in any way by a mould skin situated in the cutting seat, whereby the sensor signal serves as a measurable variable of a control circuit for which
the distance (A) between the distance sensor (85) and the cutting counterplate (81) or
the distance (A2) between the tip of the tool, i.e. the cutting blade (35) and the cutting counterplate (81) is the regulating variable and
the robot controlled device with its control circuit or at least one additional interconnected adjusting axle acts as an actuator.

2. Cutting tool according to claim 1, wherein the distance sensor (85) is configured as at least one cylindrical body which is connected with the cutting head (10) by at least one connection (40, 42) made of one or of several parts.

3. Cutting tool according to claim 1, wherein the distance sensor (85) is based on an inductive function principle.

4. Cutting tool according to claim 3, wherein the inductive sensor of the distance sensor (85) is adjusted in such a way that the distance of the inductive sensor to at least one electrically conductive object, in particular to the cutting counterplate, can be detected.

5. Cutting tool according to claim 1, wherein the control circuit
is configured as position control circuit and/or
is integrated into the cutting tool (100).

6. Cutting tool according to claim 1, wherein the connection of the control circuit with the cutting tool (100) is configured in such a manner that the measured variable, i.e. the signal of the distance sensor (85)
is amplified and
can be fed at at least one analog interface of the control in the control circuit.

7. Method for the in-process control of the residual wall thickness (A2) for the airbag weakening by means of a cutting tool (100) controlled in its motion, in particular program and/or robot controlled, for materials (70), in particular made
of P[oly]U[rethane] elastomers,
of P[oly]V[inyl]C[hloride],
of T[hermo]P[lastic]E[lastomers], even on polyester or polyether-ester base,
of T[hermo]P[lastic]O[lefins] and/or
of T[hermo]P[lastic Poly]U[rethanes]
as structural skin, as slush skin, as injection moulded skin and/or as casting skin, whereby the cutting tool (100) comprises at least one cutting head (10)
with at least one cutting blade (35) and
with at least, one blade holder (30) for the cutting blade (35), whereby the blade holder (30) with the cutting blade (35)
is set into an oscillating or pulsating cutting movement by means of at least one driving device (20) or
by means of at least one robot controlled device into a drawing forward movement producing the cut,
wherein
the cutting blade (35) for producing weakening structures along a predetermined breaking line in the material (70) of the airbag trim is moved with at least a predetermined forward speed along the predetermined breaking line and the material (70) is indented,
the distance (A) of the distance sensor (85) to a cutting counterplate (81) receiving the material to be indented (70) is measured by means of at least one distance sensor (85) placed besides the cutting tool (100) or besides the cutting blade (35) and guided together with the cutting tool (100) or together with the cutting blade (35) and
the residual wall thickness (A2) is calculated from the distance (A) measured between the distance sensor (85) and the cutting counterplate (81) minus the predetermined value kept constant during the cutting procedure for the distance (A1) of the distance sensor (85) to the base, i.e. to the bottom surface (86) of the indent in the material (70), whereby the cutting blade (85) depth is automatically readjusted in case of deviations.

8. A method according to claim 7, wherein, for the in-process control of the residual wall thickness (A2) of indented materials (70) for the formation of weakening lines or of predetermined breaking and separating lines for the airbag weakening, at least one distance sensor (85) with a principle of measurement is provided on the cutting head (10) of the cutting tool (100) next to the cutting blade (35) thereof or next to the cutting tool (100) connected with the guiding and movement device thereof for measuring the distance to the cutting counterplate (81), the principle of measurement being chosen such that the sensor signal cannot be influenced in any way by a mould skin situated in the cutting seat, whereby the sensor signal serves as a measurable variable of a control circuit for which
the distance (A) between the distance sensor (0.85) and the cutting counterplate (81) or
the distance (A2) between the tip of the tool, i.e. the cutting blade (35) and the cutting counterplate (81) is the regulating variable, whereby the robot controlled device with its control circuit or at least one additional interconnected adjusting axle acts as an actuator, whereby the residual wall thickness (A2) is calculated from the value of the distance (A) between the distance sensor (85) and the cutting counterplate (81) minus the height difference (A1) between the distance sensor (85) and the tip of the cutting blade (35).

9. Method according to wherein the connection of the control circuit, in particular of the position control circuit, with the cutting tool (100) is configured in such a manner that the measured variable, i.e. the signal of the distance sensor (85) is
amplified and
fed to at least one analog interface of the control into the control circuit.

10. Use of at least one cutting tool (100) according to claim 1 and/or of a method according to claim 7 for the production of airbag trims with weakening structures, in particular for the formation of weakening lines or predetermined breaking and separating lines in materials (70) provided for the trim of airbags, for example made
of P[oly]U[rethane] elastomers,
of P[oly]V[inyl]C[hloride],
of T[hermo]P[lastic]E[lastomers], even on polyester or polyether-ester base,
of T[hermo]P[lastic]O[lefins] and/or
of T[hermo]P[lastic Poly]U[rethanes]
as structural skin, as slush skin, as injection moulded skin and/or as casting skin.
